(19) United States
(12) Patent Application Publication
(10) Pub. No.: US 2015/0032502 A1
(43) Pub. Date: Jan. 29, 2015

(54) SYSTEMS AND METHODS FOR SALES AND INVENTORY MANAGEMENT

(71) Applicant: Askuity Inc., Toronto (CA)

(72) Inventors: Eric Green, Toronto (CA); Neal Sherman, Toronto (CA)

(73) Assignee: Askuity Inc., Toronto (CA)

(21) Appl. No.: 14/242,738

(22) Filed: Apr. 1, 2014

Related U.S. Application Data
(60) Provisional application No. 61/859,499, filed on Jul. 29, 2013.

(51) Int. Cl. G06Q 20/20; G06Q 30/02

(52) U.S. Cl. CPC G06Q 20/203; G06Q 30/0201; G06Q 30/0238
USPC 705/7.29; 705/22; 705/14.38

(57) ABSTRACT

A method for sales and inventory management of items offered for sale by at least one merchant and supplied by at least one vendor is disclosed. The method may include configuring a sales and inventory management utility and report generator using a processor coupled to a data storage device. It may also include receiving, by the sales and inventory management utility, a plurality of sets of retailer inventory data from a plurality of retailer systems, wherein each set of retailer inventory data identifies a plurality of items, a tag, and for each of the plurality of items, a stock keeping unit (SKU), a quantity in stock, a retailer, and a vendor. The method may store the plurality of sets of retailer inventory data as a plurality of retailer item records stored on the data storage device, each item record identifying an item of the plurality of items, the SKU, the quantity in stock, a retailer code for the retailer system, and a vendor code for the vendor, and then receive, by the sales and inventory management utility, point-of-sale data feeds from one or more retailer systems from the plurality of retailer systems, wherein the point-of sale data feeds comprises sales data, wherein the sales data identifies one or more items of the plurality of items, a retailer, and a quantity sold. For each of the one or more items identified in the sales data, the method may update, by the sales and inventory management utility, the retailer item record on the data storage device by adjusting the quantity in stock based on the quantity sold, and generate, by the report generator, a sales and inventory report based on the sales inventory data stored on the data storage device.

### FIELD

The embodiments described herein relate to systems and methods for sales and inventory management, and in particular, to systems and methods for sales and inventory management using point-of-sale transaction data.

### INTRODUCTION

Vendors selling products to retailers may not have easy and consistent access to Point-of-Sale (POS) data for their products, even though this type of information is important to their ongoing business. Similarly, retailers may also not have easy and consistent access to POS data for their products. Basic information such as units sold per store, units in stock in inventory, and average selling price may be important to both vendors and retailers to make informed decisions about product assortment, promotional spending, and inventory levels.

Yet across most retailers, this retail POS data is generally not harnessed or shared by retailers in a systematic or programmatic way that would enable valuable collaboration between retailers and product vendors. Vendors, particularly small to midsized ones, are often left to secure data through a combination of one-off ‘favors’ and unofficial channels. Even in those cases where retailers do have reports that they share with vendors, the data shared is typically unreliable and not up-to-date, limited in its scope and may require significant formatting, manipulation and processing on the vendor side. These capabilities may not generally be present in most supplier organizations.

Data services firms may offer outsourced services to scrub, reformat and share this data to vendors for a sizable fee. These services, however, may offer limited functionality and flexibility for vendors wanting to drill down into the details of their business and product sales. Further, because they are not ‘retailer-sponsored’ programs, the data service provider may have to deal with suboptimal data, leading to manual cycles to rework and reformat the data that they're being sent by the retailer. In addition, quite often, data may simply not be available at all from key retailers, rendering the service marginally useful for large groups of vendors.

Retailer specific systems may collect POS data using limited reporting tools and receive tabular reports, which then need to be manipulated in other software to understand.

### SUMMARY OF THE INVENTION

Embodiments of the invention may include a method for sales and inventory management of items offered for sale by at least one merchant and supplied by at least one vendor including:

configuring a sales and inventory management utility and report generator using a processor coupled to a data storage device;

receiving, by the sales and inventory management utility, a plurality of sets of retailer inventory data from a plurality of retailer systems, wherein each set of retailer inventory data identifies a plurality of items, a tag, and for each of the plurality of items, a stock keeping unit (SKU), a quantity in stock, a retailer, and a vendor;

storing the plurality of sets of retailer inventory data as a plurality of retailer item records stored on the data storage device, each item record identifying an item of the plurality of items, the SKU, the quantity in stock, a retailer code for the retailer system, and a vendor code for the vendor;

receiving, by the sales and inventory management utility, point-of-sale data feeds from one or more retailer systems from the plurality of retailer systems, wherein the point-of sale data feeds comprises sales data, wherein the sales data identifies one or more items of the plurality of items, a retailer, and a quantity sold;

for each of the one or more items identified in the sales data, updating, by the sales and inventory management utility, the retailer item record on the data storage device by adjusting the quantity in stock based on the quantity sold; and

generating, by the report generator, a sales and inventory report based on the sales inventory data stored on the data storage device.

The method may further include:

configuring an alert generator using the processor;

receiving, by the alert generator, an alert threshold for an item of the plurality of items, wherein the alert threshold comprises a minimum quantity in stock for the item;

adding the minimum quantity in stock to the retailer item record for the item;

determining, by the alert generator, that the quantity in stock for the item is less than the minimum quantity in stock for the item; and

generating, by the alert generator, an alert for the item to order additional quantities from the vendor for the item.

Other embodiments may include:

configuring an marketing utility using the processor;

receiving, by the marketing utility, merchandising and marketing data, wherein the merchandising and marketing data corresponds to one or more items of the plurality of items;

storing the merchandising and marketing data as a marketing records on the data storage device;

generating, by the report generator, a marketing report using the marketing records stored on the data storage device.

The method of claim 1 further comprising:

receiving a vendor item code for an item of the plurality of items, wherein the vendor item code for the item is different than SKU for the item; and

adding the vendor item code to the retailer item record for the item;

wherein the report is generated based on the vendor item code;

Other embodiments may include:

receiving a coupon code for an item of the plurality of items, wherein the coupon code identifies a discount on the item;

adding the coupon code to the retailer item record for the item;

wherein the sales data identifies the coupon code and indicates that discount was given on the item.

Other embodiments may include:

receiving reporting metrics, wherein the report metrics correspond to contents of the retailer item records;

wherein the report is generated based on the reporting metrics.

Other embodiments may include, wherein the sales data identifies customer data for each of the one or more items:

for each of the one or more items, storing the customer data as a customer record on the data storage device, wherein the customer record comprises a customer identifier and the SKU for the item.

Other embodiments may include:

receiving, by the sales and inventory management utility, additional retailer inventory data from another retailer system, wherein the additional retailer inventory data identifies a plurality of additional items, and for each of the plurality of additional items, a SKU, a quantity in stock and a vendor;

storing the additional retailer inventory data as a plurality of additional retailer item records stored on the data storage device, each additional item record identifying an item of the plurality of additional items, the SKU, the quantity in stock, a retailer code identifying the other retailer system, and a vendor code identifying the vendor;

receiving, by the sales and inventory management utility, additional point-of-sale data feeds from the other retailer system, wherein the additional point-of sale data feeds comprises additional sales data, wherein the additional sales data identifies one or more items of the plurality of additional items and a quantity sold; and

for each of the one or more items identified in the additional sales data, updating, by the inventory management utility, the retailer item record on the data storage device by adjusting the quantity in stock based on the quantity sold.

Other embodiments may include:

receiving a report request comprising a vendor code; and

wherein the report is generated based on the vendor code and by aggregating data based on retailer code across multiple retailer systems.

Variations may include, wherein the retailer inventory data identifies for each of the plurality of items, a cost per unit, and wherein, for each of the plurality of items, the retailer item record for the item comprises the cost per unit, cost margin, revenue, and wherein the method further comprises, aggregating, by the report generator based on the vendor code, a total number of units of items sold and a total sales amount based on the costs per unit of items sold, wherein the report comprises the total number of units of items sold.

Other variations may include, wherein the vendor code is associated with a vendor system, and wherein the method further comprises:

transmitting the report to the vendor system,

Other embodiments may include, wherein each item record identifies a retailer location.

Other embodiments may include aggregating, by the report generator based on the retailer location, a total number of units of items sold per location and a total sales amount per location based on the costs per unit of items sold.

Variations may include wherein the report has, for each retailer item record having a retailer code identifying the retailer system, the SKU and the quantity in stock.

Other embodiments may include receiving a selection of tags or item metrics, wherein the item metrics correspond to contents of the retailer item records, and wherein the method further includes generating the report, by the report generator, based on selected metrics.

Other embodiments may include a system for sales and inventory management of items offered for sale by at least one merchant and supplied by at least one vendor, the system having:

a data storage device;

a processor coupled to the data storage device;

a sales and inventory management utility configured by the processor to:

receive retailer inventory data from a retailer system, wherein the retailer inventory data identifies a plurality of items, and for each of the plurality of items, a stock keeping unit (SKU), a quantity in stock, and a vendor;

store the retailer inventory data as a plurality of retailer item records stored on the data storage device, each item record identifying an item of the plurality of items, the SKU, the quantity in stock, a retailer code identifying the retailer system, and a vendor code identifying the vendor;

receive point-of-sale data feeds from the retailer system, wherein the point-of sale data feeds comprises sales data, wherein the sales data identifies one or more items of the plurality of items and a quantity sold;

for each of the one or more items identified in the sales data, update the retailer item record on the data storage device by adjusting the quantity in stock based on the quantity sold; and

a report generator configured by the processor to generate a sales and inventory report based on the sales and inventory data stored on the data storage device.

Other embodiments may include:

an alert generator configured by the processor to receive an alert threshold for an item of the plurality of items, wherein the alert threshold comprises a minimum quantity in stock for the item;

wherein the sales and inventory management utility is further configured to add the minimum quantity in stock to the retailer item record for the item; and

and wherein the alert generator is further configured to determine that the quantity in stock for the item is less than the minimum quantity in stock for the item; and generate an alert for the item to order additional quantities from the vendor for the item.

Other embodiments may include:

a marketing utility configured by the processor to receiving merchandising and marketing data, wherein the merchandising and marketing data corresponds to one or more items of the plurality of items;

wherein the sales and inventory management utility is further configured to store the merchandising and marketing data as a marketing records on the data storage device;

wherein the report generator is further configured to generate a marketing report using the marketing records stored on the data storage device.

The system of claim 16, further comprising:

a user interface utility configured by the processor to generate a user interface for display on the retailer system, the user interface configured to receive input data and provide output data.

Other embodiments may include a computer-readable storage medium storing one or more sequences of instructions which, when executed by one or more processors, causes the one or more processors to perform a method for sales and inventory management of items offered for sale by at least one merchant and supplied by at least one vendor, the method comprising:

configuring a sales and inventory management utility and report generator using a processor coupled to a data storage device;

receiving, by the sales and inventory management utility, retailer inventory data from a retailer system, wherein the retailer inventory data identifies a plurality of items, and for each of the plurality of items, a stock keeping unit (SKU), a quantity in stock, and a vendor;

storing the retailer inventory data as a plurality of retailer item records stored on the data storage device, each item record identifying an item of the plurality of items, the SKU, the quantity in stock, a retailer code identifying the retailer system, and a vendor code identifying the vendor;

receiving, by the sales and inventory management utility, point-of-sale data feeds from the retailer system, wherein the point-of sale data feeds comprises sales data, wherein the sales data identifies one or more items of the plurality of items and a quantity sold;

for each of the one or more items identified in the sales data, updating, by the sales and inventory management utility, the retailer item record on the data storage device by adjusting the quantity in stock based on the quantity sold; and

generating, by the report generator, a sales and inventory report based on the sales and inventory data stored on the data storage device.

### DRAWINGS

Various embodiments will now be described, by way of example only, with reference to the following drawings, in which:

FIG. 1 is a schematic diagram of a system for sales and inventory management according to some embodiments;

FIG. 2 is a schematic diagram of a retailer system according to some embodiments;

FIG. 3 is a schematic diagram of a vendor system according to some embodiments;

FIG. 4 is a schematic diagram of a sales and inventory management system in further detail for according to some embodiments;

FIG. 5 is a flow chart diagram of a method for sales and inventory management according to some embodiments;

FIG. 6 is a flow chart diagram of another method for sales and inventory management according to some embodiments;

FIG. 7 is a flow chart diagram of a further method for sales and inventory management according to some embodiments;

FIG. 8 is an example user interface displaying sales and inventory management data according to some embodiments;

FIG. 9 is another example user interface displaying sales and inventory management data according to some embodiments;

FIG. 10 is a further example user interface displaying sales and inventory management data according to some embodiments; and

FIG. 11 is another example user interface displaying sales and inventory management data according to some embodiments.

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

### DESCRIPTION OF VARIOUS EMBODIMENTS

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer useable instructions may also be in various forms, including compiled and non-compiled code.

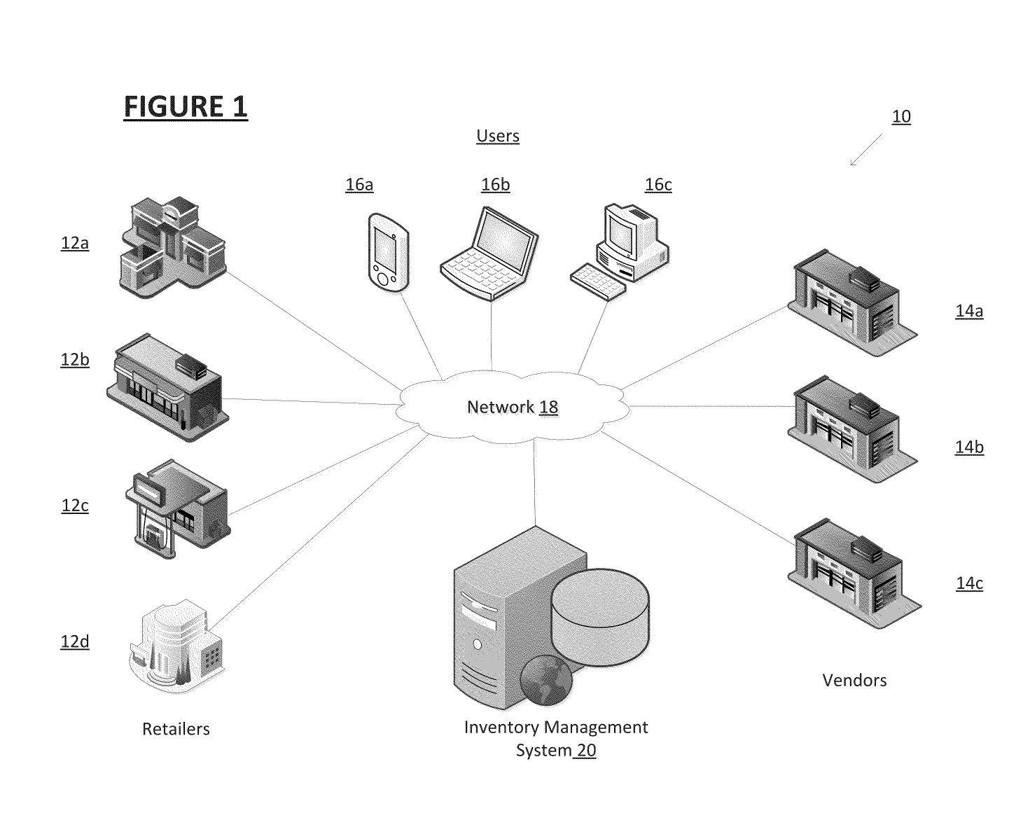

FIG. 1 is a schematic diagram of a system 10 for sales and inventory management according to some embodiments.

System 10 includes a sales and inventory management system 20, which in some example embodiments, may be web-based business intelligence hardware platform that allows retailers to quickly and easily access and analyze POS, inventory and sales data, and allows vendors to quickly and easily access and analyze POS data from across participating retailers. The powerful analytics suite may enable comprehensive analysis of the vendor's and retailer's critical POS data at store level, multi-store level, multi-vendor level, multi-retailer level, and so on. The POS data may include units and dollars sold, inventory in-stock, inventory on-order, average selling price for products, and so on. Various interfaces (e.g. dashboards) and reports may be dynamically customizable by users and may be automatically updated with the most current data from the retailers. Historical data may be maintained for each vendor and retailer, enabling analyses of trends over time and period-over-period performance.

Sales and inventory management system 20 may provide dynamic reports to give insight into sales and inventory trends across a variety of retailers. Sales and inventory management system 20 may provide a variety of report types such as, for example, benchmarking reports (e.g. benchmark different data sets), visual reports (e.g. graphs, charts), integrated reports (e.g. correlation across different data sets) and so on. Reports may include a variety of types of correlated data sets such as, for example, POS data, historical data, data over different time periods, data from different vendors, data from different retailers, data for different categories of goods or services, and the like.

The inventory management system 20 may be a Software as a Service (SaaS) networked hardware application, which may require limited software and hardware implementation on the vendor side as it may be accessed through a compatible web browser. On the retailer side, an application interacting with inventory management system 20 may sit separate from its operational POS technology infrastructure and may require limited to no systems integration. Periodic, optimized POS data feeds may be received by sales and inventory management system 20 (which may be referred from the retailer system 12 and may hosted in a secure data warehouse (e.g. inventory management system 20, or a data storage device linked thereto) that drives reporting and analytical applications. There may be no interference with a retailer's live financial systems.

As an illustrative and non-limiting example, vendors may pay a small monthly fee to the retailer for access to the inventory management system 20 and their data. Fees may be calculated off business volume with the retailer, such as for example a range from 0.125% to 1% of a vendor's wholesale sales to a particular retailer. This is a non-limiting illustrative example.

This program fee may be assessed across the supplier base as a mandatory program cost (e.g. deduction off invoice), which may be similar to a co-op marketing program or in-store service program. The fee may be justified based on added-value that the service offers to the vendor, particularly in comparison to other program costs that vendors may routinely pay as a cost of doing business (other deductions typically range from 1-3% of sales).

Sell-through and inventory data is at the core of a vendor's business as it drives most key financial metrics either directly or indirectly. Without it, vendors may be blind to the true impact of their promotional, merchandising and pricing programs and cannot be sure that they are optimizing spends with any customer or across customers. Inventory management system 20 may process the POS data to help with production forecasting and inventory management as it may provide the lowest level of sales data that can then be rolled up into predicted customer orders. Increased visibility as to how a new product is selling within the first few days on shelf may allow vendors to get ahead of the demand curve and ensure stock-outs or short-shipments do not occur, or occur with less frequency.

Given that in most cases products are shipped to retailer distribution centers (DC) which in turn service anywhere from 100 to 200 stores, accurate granular level sell-through and on-hand inventory information may be calculable by inventory management system 20 using store level information provided by retailer DCs.

For example, if Retailer A's DC in the Atlanta area services its 200 stores throughout Georgia and Florida, Vendor A may have only a limited idea where its products are selling once the product leaves its dock for that Atlanta DC. It may be possible that 80% of its sales are corning from 20% of the region's stores that are located in urban markets while it may be selling virtually nothing in the rural stores. In this case, Vendor A might ‘double-down’ on its marketing spend targeted at urbanites to entrench itself in that customer base; alternatively, it might adjust its marketing program targeting the rural customer to raise the level of awareness in that market and therefore grow its sales. Inventory management system 20 is operable to provide this data at different levels of granularity across multiple retailers. At a more micro level, it's possible that there are large groups of retailers that aren't selling any product because it's not in stock or it hasn't been merchandised properly. In both these cases, having that store level information (e.g. as provided by inventory management system 20) allows the vendor to take the appropriate steps and make the strategic decisions necessary to improve its business and address any field-level issues that might arise before they negatively impact sales.

Inventory management system 20 may provide inventory data at the retailer and store level, information that can be most useful to optimizing marketing program spends, particularly those which gea-target to very specific markets or stores (e.g., in-store demos, online marketing such as Google Adwords, Facebook ads). Additionally, inventory management system 20 may provide real-time (or near real-time) data at the store level. With millions of dollars of ad dollars at stake, a gap in timing may lead to expensive mistakes, increasing the importance of timely and dynamic data.

Inventory management system 20 is operable to provide a web-based software and hardware suite that may provide dashboard insights, self-serve real time analysis and may eliminate the need for and expense of the manual off-line workarounds (or outsourced services) that companies may currently use to make sense of the raw data provided by the retailer.

Sharing POS data with vendors gives vendors better knowledge of how their products are selling in-store across multiple vendors, and how sales are reacting to various promotional programs. It also allows vendors to identify and address inventory issues at store level before they develop into full-blown overstock and markdown problems.

Retailers are increasingly relying on their vendors to provide expertise in merchandising, promotion and pricing—elements that drive joint sales—but it may be very difficult for vendors to contribute to this conversation without any data. By improving visibility of this store level information using inventory management system 20, retailers and vendors can truly partner to improve joint business performance.

The level of data provided by inventory management system 20 may increase visibility and ease of use would encourage retail buyers and category managers to use the application as well, drawing newer and better insights into how their categories and assortments are performing across the chain, right down to individual SKUs and stores. The complexity of the enterprise reporting systems that buyers have access can discourage buyers from making full use of this information outside of the annual or semi-annual planogram review cycle. Inventory management system 20 may provide ease-of-use and mobile functionality (for use during regular buyer store walks) and may put key information at buyers' fingertips, enabling better merchandising decisions year-round.

Beyond the business benefits that may accrue to Retailers, inventory management system 20 may form the basis of a new, incremental and significantly profitable vendor program. By deploying the service as a standard platform across all vendors and retailers at a nominal monthly cost per vendor, the program has the potential to produce an incremental revenue stream for the retailer with little to no cost.

Furthermore, to the extent that retailers are already sending out this information, even charging for it in some cases, inventory management system 20 may enable them to avoid personnel, hardware and software costs associated with their program. This may actually increase their revenue streams, given the additional functionality of the inventory management system 20 over their current flat file transfers and the broader application to the entire vendor base.

Inventory management system 20 deployment costs to the retailer may be minimal and may include project resources to assist and validate initial data mapping for data exports.

Inventory management system 20 may give retailers and vendors access to a value-added business intelligence interface which may require limited to no ongoing involvement or costs from the retailer's technology department. Inventory management system 20 may also offer increased revenue to the retailer since their existing service may be limited to the largest vendors (presumably because of the costs and limited capacity available on the retailer's side to manage this process). Inventory management system 20 automated data warehousing may extend the solution to all vendors for multiple retailers as a standard program and may therefore increase the size of the revenue stream. Inventory management system 20 may offer an advanced self-service business intelligence functionality and may enable retailers to deploy a tool for its vendors with little to no development cost and a significant incremental revenue stream. Inventory management system 20 may provide data that is granular store-level data and item-level data.

Inventory management system 20 may provide dynamic reports to give insight into inventory and sales trends across multiple retailers. The reports may be focused by vendor and aggregate retailer data based on item identifiers. Inventory management system 20 may provide a communication platform between retailers and vendors and may automatically send messages and alerts in response to triggers. The reports may be flexible and dynamic, generated based on report parameters that may update.

Inventory management system 20 may be implemented using a server and data storage devices configured with database(s) or file system(s), or using multiple servers or groups of servers distributed over a wide geographic area and connected via a network 18. Inventory management system 20 may be connected to a data storage device directly or to a cloud based data storage device via network 18. Inventory management system 20 may reside on any networked computing device including a processor and memory, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these.

Inventory management system 20 may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Inventory management system 20 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

Inventory management system 20 may include one or more input devices, such as a keyboard, mouse, camera, touch screen and a microphone, and may also include one or more output devices such as a display screen and a speaker. Inventory management system 20 has a network interface in order to communicate with other components, to serve an application and other applications, and perform other computing applications by connecting to network 18 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one inventory management system 20 is shown for clarity, there may be multiple inventory management systems 20 or groups of inventory management systems 20 distributed over a wide geographic area and connected via e.g. network 18.

Inventory management system 20 generally connects with or includes one or more data storage devices (e.g., memory, and the like), and could include a relational database (such as a SQL database, noSQL or non-relational database), or other suitable data storage mechanisms. Data storage devices are operable to store data records for inventory management system 20, and associated applications such as data for provision to retailer systems 12, vendor systems 14, user devices 16 or data received from retailer systems 12, vendor systems 14, user devices 16. The cloud based data storage device may be accessible to retailer systems 12, vendor systems 14, user devices 16 through a cloud services interface. Cloud computing generally is the use of computing hardware and software resources that are delivered as a service over a network 18 to retailer systems 12, vendor systems 14, user devices 16.

Data storage devices may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

In some embodiments, inventory management system 20 may also have one or more backup servers that may duplicate some or all of the data stored on the data storage devices. The backup servers may be desirable for disaster recovery (e.g., to prevent undesired data loss in the event of an event such as a fire, flooding, or theft). In some embodiments, the backup servers may be directly connected to inventory management system 20 but located at a different physical location.

Network 18 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although not shown, inventory management system 20, retailer systems 12, vendor systems 14, user devices 16, and other components (not shown) may connect to network 18 via a firewall, which is a device, set of devices or software that inspects network traffic passing through it, and denies or permits passage based on a set of rules and other criteria. Firewall may be adapted to permit, deny, encrypt, decrypt, or proxy all computer traffic between network 18, inventory management system 20, retailer systems 12, vendor systems 14, user devices 16, and other components based upon a set of rules and other criteria. For example, firewall may be a network layer firewall, an application layer firewall, a proxy server, or a firewall with network address translation functionality. Network 18 is operable to secure data transmissions using encryption and decryption.

User device 16 is operable by a user and may be any portable, networked (wired or wireless) computing device including a processor and memory and suitable for facilitating communication between one or more computing applications of user device 16 (e.g. a computing application installed on or running on the user device 16), the cloud services provided by inventory management system 20.

In accordance with some embodiments, user device 16 may be a mobile computing device 16a. A mobile computing device may be a two-way communication device with advanced data communication capabilities having the capability to communicate with other computer systems and devices. The mobile device may include the capability for data communications and may also include the capability for voice communications. Depending on the functionality provided by the mobile device, mobile device may be referred to as a portable electronic device, smartphone, a data messaging device, a two-way pager, a cellular telephone with data messaging capabilities, personal digital assistant, a wireless Internet appliance, a tablet computer, a media player, an electronic reading device, a data communication device (with or without telephony capabilities) or a combination of these. User device 16 may also include other types of computing devices such as a portable laptop computer 16b or a desktop computer 16c. These are non-limiting examples and other computing devices including a processor and storage device may be used. Although only 3 user devices 16 are illustrated in FIG. 1, there may be fewer or more user devices 16 connected via network 18. User device 16 may be connected within system 10 via any suitable communications channel. For example, the user device 16 may communicate within the system 10 over a Local Area Network (LAN) or intranet, or using an external network. User device 16 may also have additional embedded components such as a global positioning system (GPS), a clock, a calendar, and so on.

User device 16 may be configured with various computing applications to access the functionality of inventory management system 20. A computing application may correspond to hardware and software modules comprising computer executable instructions to configure physical hardware to perform various functions and discernible results. A computing application may be a computer software or hardware application designed to help the user to perform specific functions, and may include an application plug-in, a widget, instant messaging application, mobile device application, e-mail application, online telephony application, java application, web page, or web object residing, executing, running or rendered on the user device 16. User device 16 is operable to register and authenticate users (using a login, unique identifier, and password for example) prior to providing access to applications and inventory management system 20. User devices 16 may be different types of devices and may serve one user or multiple users.

Inventory management system 20 connects to one or more retailer systems 12 and vendor systems 14. Vendors associated with vendor systems 14 supply items (e.g. products, services, etc.) to retailers associated with retailer systems 12. Retailer systems 12 then stock the items in various stores for sale to customers. Users of user devices may be associated with retailer systems 12, vendor systems 14 or may be otherwise interested in inventory related data (e.g. third party marketing agencies). Retailer systems 12 and vendor systems 14 may relate to various industries such as for example, grocery, convenience, home improvement, sporting goods, electronics, apparel, automotive, office supply, specialty, and so on.

Vendor systems 14 may provide inventory data relating to various items to inventory management system 20, and may receive granular level (e.g. store, item) sales, marketing and inventory data in reports from inventory management system 20. Vendor systems 14 may receive reports that aggregate data across multiple retailers. This may help vendor systems 14 with delivery, production and marketing planning. Retailer systems 12 may provide inventory data and real-time, near real-time, current POS data relating to in-stock items to inventory management system 20, and may receive may receive granular level (e.g. store, item) sales, marketing and inventory data in reports from inventory management system 20.

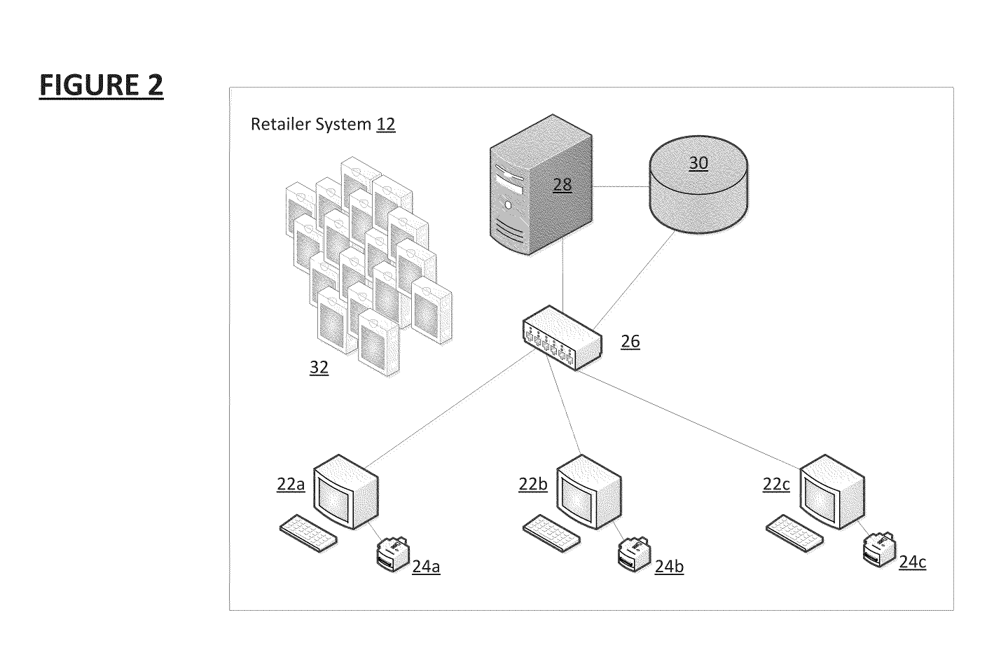

FIG. 2 is a schematic diagram of a retailer system 12 according to some embodiments.

Retailer system 12 may be used to manage one or more fixed locations (e.g. retail stores, markets), or door-to-door or delivery services. Retail is the sale of goods and services 32 from individuals or businesses to customers (e.g. businesses, individuals). Retailer system 12 is part of an integrated supply chain system. A retailer purchases goods or products in large quantities from vendors (associated with vendor system 14) directly or through a wholesaler, and then sells smaller quantities to customers for a profit. A retailer may be a service provider that services a large number of customers, such as for the public or private members. As an illustrative example, retailer system 12 may be associated with a grocery store, department store, clothing store, market, sporting goods store, etc.

Retailer system 12 may include an inventory of items 32 (e.g. goods, services) for sale to customers. Retailer system 12 may be used to manage POS transactions. A POS may be a point of contact between retailers and customers where tender is exchanged for desired goods or services.

Retailer system 12 may include a POS central controller 28 which is a computing device executing a hardware and software POS application (locally or cloud-based) that allows the retailer to process and manage POS transactions, print receipts and reports associated with the transactions, etc. POS central controller 28 may be connected to a data storage device 30 to store and aggregate data collected from POS terminal stations 22a. The POS central controller 28 may also receive inventory data about items 32 in-stock, and store and aggregate inventory data on data storage device 30. The POS central controller 28 may manage a database system including a price table, inventory table, and the like.

A POS (e.g. check-out) terminal station 22 may be a point of contact between an employee of retailer and a customer in order to process a POS transaction (e.g. exchange of tender for desired goods or services). A POS terminal station 22 may include a computing device to receive POS transaction data (e.g. SKU, payment details), process POS transactions, generate POS transaction data, and transmit a POS transaction data stream to POS central controller 28 for processing, storage, and further transmission. A POS terminal station 22 may include output and input devices to provide and receive POS transaction data. For example, POS terminal station 22 may connect to one or more POS peripherals 24 (e.g. display, scanner, printer, keypad, card reader, signature pad, touch pad, scale, payment device, NFC device) to provide and receive POS transaction data. There may be multiple POS terminal stations 22a, 22b, 22c each operable by an operator and connected to a respective peripheral 24a, 24b, 24c.

The POS central controller 28 and POS terminal stations 22 (or POS peripherals 24) may be connected to a third party financial system (not shown), such as a retailer bank, card-issuer, customer bank, etc., to process and approve financial POS transactions. There may be more POS central controllers 28 connected via network 26 hub. There may be fewer or more POS terminal stations 22 connected via network 26 hub. One or more POS terminal stations 22 may share a POS peripheral 24 via network 26 hub. Details regarding data storage devices, computing devices, and networks are described herein in relation to FIG. 1. Retailer system 12 may be spread over multiple locations or stores. There may be multiple retailer systems 12 connected over a network to a common POS central controller 28. POS central controllers 28 may be connected to one or more POS central controllers 28 in a tiered manner to aggregate data for a retailer. A retailer system 12 may vary and in some examples may include fewer or more components than those illustrated in FIG. 2. There may be a backup storage device as described above in relation to FIG. 1.

A POS transaction data stream may include various data fields relating to a transaction, such as date, time, location, items, amount, description, quantities, subtotal, tax, discounts/coupons, total charge, payment method, payment data, location, transaction identifier, item identification code, customer data, loyalty program data, tag, retailer code, and the like. These are non-limiting, illustrative example POS transaction data fields.

Items 32 in inventory that are stocked and sold by retailer system 12 may be associated with a Stock Keeping Unit (SKU). A SKU may be a number, string of alpha and numeric characters, code, image, etc. that uniquely identifies a product. A SKU (e.g. item identification code) may be used by retailer system 12 to automatically identify items that retail establishment carries in inventory. The SKU may be a unique code in unambiguously identify a product. A SKU may or may not be machine readable. For example, a machine readable code may be automatically read by POS peripheral 24 (e.g. scanner) for acquisition by POS terminal stations 22. A SKU may be a machine-readable bar code. As another example, a non-machine readable code may be manually input into a POS peripheral 24 (e.g. keypad) for acquisition by POS terminal stations 22. A SKU helps an item 32 to be tracked for inventory (e.g. as an index for an item in an inventory table managed by POS central controller 28). A SKU may also be used to look-up a cost or price associated with an item 32 (e.g. index for a look-up in a pricing table managed by POS central controller 28).

An SKU does not need to be assigned to physical items 32 in inventory. SKUs may apply to intangible, but billable products, such as units of repair time, delivery fees, licenses, or warranties. For this reason, a SKU can be thought of as a code assigned to a retailer's billable entities. Example SKUs include part numbers, model numbers, product codes, product identifiers, product numbers, identification codes, UPC codes, image, QR codes, barcodes, 2D codes, EANs, GTINs, APNs, machine-readable codes, optically-readable codes, magnetically-readable codes, electrostatically-readable codes, electronically-readable codes, or codes which are scannable or readable by electromagnetic, mechanical, electrical, electronic mechanisms, optical mechanisms and the like. A SKU may have subcomponents to connect a family of related items 32.

A SKU may be universal (e.g. UPC code or supplier part number) in that multiple parties (e.g. vendors, retailers) may use the same SKU to identify the same item 32. A SKU may specific to one or more retailers, such that another party (e.g. vendors, another retailer) use a different SKU to identify the same item 32. As will be explained here inventory management system 20 may create a link between a retailer specific SKU and a vendor specific SKU in order to correlate data relating to the same item 32.

A SKU may be used by retailer system 12 to automatically identify an item 32 for inventory and POS transaction purposes. For example, a SKU may be used to determine how many units of a particular item 32 are currently in-stock in a particular retailer location. As another example, a SKU may be used to look-up an item's 32 current cost, vendor etc. A SKU is linked to retailer item record storing cost, location in retail store, unit of measure, and other useful information about a transaction or item 32.

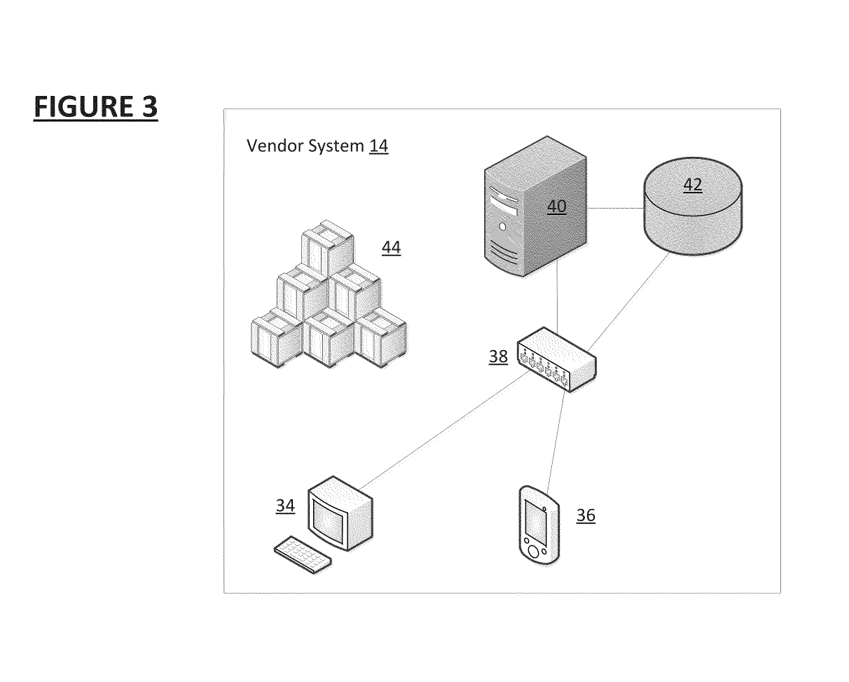

FIG. 3 is a schematic diagram of a vendor system 14 according to some embodiments.

A vendor, or a supplier, may be associated with vendor system 14. A vender refer to an enterprise that contributes goods or services in a supply chain. Generally, a supply chain vendor manufactures and/or distributes inventory/stock items 44 and sells them to the next link in the chain (e.g. retailer).

Vendor system 14 may include inventory items 44 (e.g. goods, services) for sale to retailers, wholesalers, and the like. Vendor system 14 may be used to supply of inventory items 44, and merchandising and marketing data for merchandising and marketing thereof.

Vendor system 14 may include a vendor central controller 40 which is a computing device executing a hardware and software supply application (locally or cloud-based) that allows the vendor to manage the supply of inventory items 44 to retailers. Vendor central controller 40 may be connected to a data storage device 42 to store and aggregate inventory and supply data collected from vendor stations 34, retailer systems 12, and other vendor systems 14. The vendor central controller 40 may receive inventory data about inventory items 44 in-stock in vendor's warehouse and vendor's items 32 in-stock with retailer systems 12. The vendor central controller 40 can and store and aggregate inventory data on data storage device 42. The vendor central controller 40 may manage a database system including a price table, inventory table, and the like.

A vendor station 34, 36 may be operated by an employee of vendor to manage inventory items 44 in warehouse and provide real-time data regarding vendor and inventory items 44 (e.g. to report of current stock, incoming items 44, outgoing items 44, discontinued items 44, backorder items 44). Vendor station 34, 36 may be a stationary computing device 34 or a portable computing device 36 to receive vendor and item data, generate vendor and item data, and transmit vendor and item data stream to vendor central controller 40 for processing, storage, and further transmission. A vendor station 34, 36 may include output and input devices to provide and receive vendor and item data. For example, vendor station 34, 36 may connect to one or more peripherals (e.g. display, scanner, printer, keypad, card reader, signature pad, touch pad, scale, payment device, NFC device) to provide and receive vendor and item data. There may be multiple vendor stations 34, 36 each operable by an operator and connected to a respective peripheral.

There may be more vendor central controllers 40 connected via network 38 hub. There may be fewer or more vendor station 34, 36 connected via network 38 hub. One or more vendor stations 34, 36 may share a peripheral via network 38 hub. Details regarding data storage devices, computing devices, and networks are described herein in relation to FIG. 1. Vendor system 14 may be spread over multiple locations or stores. There may be multiple vendor systems 14 connected over a network to a common POS central controller 40. Vendor central controllers 40 may be connected to one or more other vendor central controllers 40 in a tiered manner to aggregate data for a vendor. Vendor system 14 may vary and in some examples may include fewer or more components than those illustrated in FIG. 3. There may be a backup storage device as described above in relation to FIG. 1. Vendor system 14 may connect to inventory management system 20 and retailer system 12.

Inventory items 44 stocked and sold by vendor system 14 may be associated with SKU (as described herein in relation to FIG. 2). The vendor SKU (or vendor item code) may or may not be the same SKU used by one or more retailer systems 12. As will be explained herein, inventory management system 20 may create a link between a retailer specific SKU and a vendor specific SKU in order to correlate data relating to the same item 44. This in turn, may create a link between a vendor specific SKU and multiple retailer codes, so that data for a vendor may be aggregated across a variety of retailers. A SKU may be used by vendor system 14 to automatically identify an inventory item 44 for stocking, sales and distribution purposes. For example, a SKU may be used to determine how many units of a particular inventory item 44 are currently in-stock in a particular vendor warehouse. A SKU is linked to vendor item record useful information about an item 44.

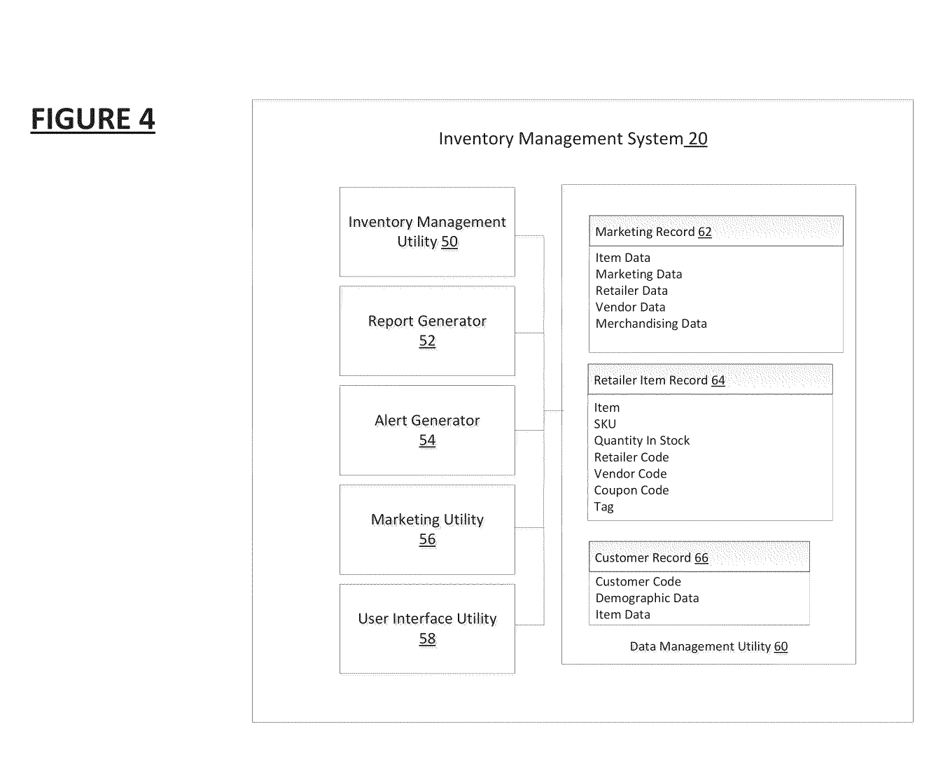

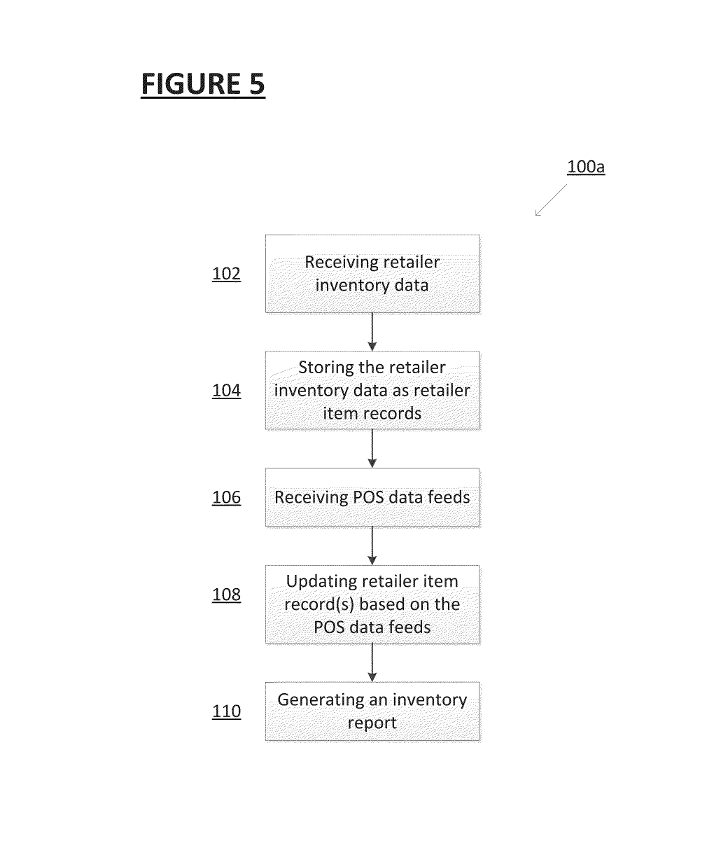

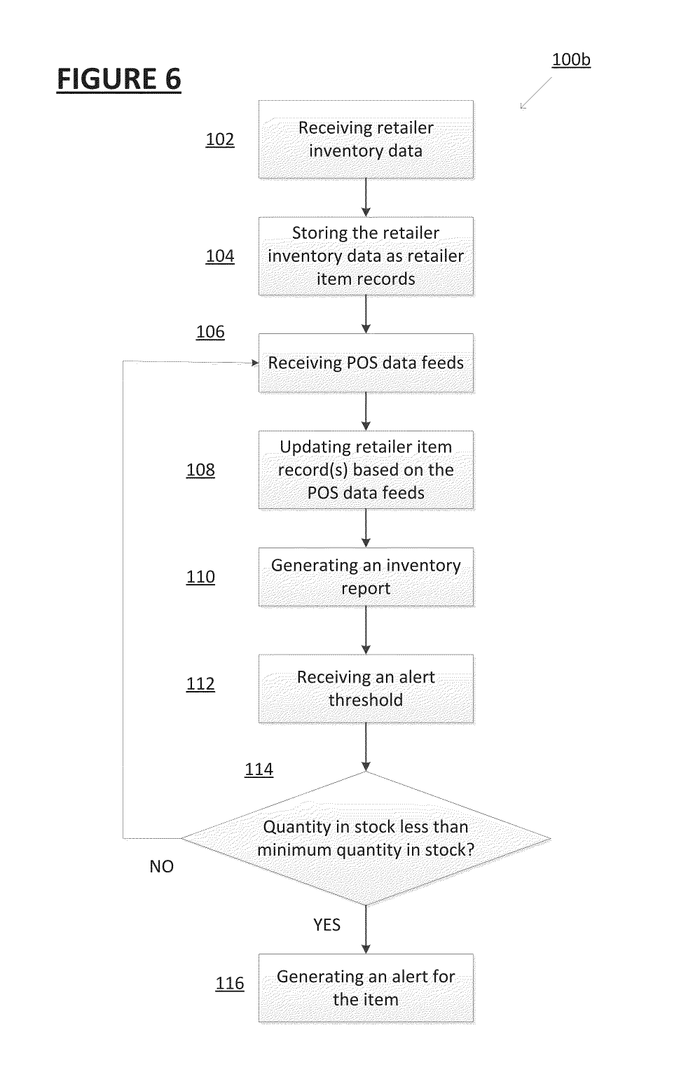

FIG. 4 is a schematic diagram of an inventory management system in further detail for according to some embodiments. Reference will also be made to FIGS. 5, 6 and 6 which show flow chart diagrams of example methods 100a, 100b, 100c for inventory management according to some embodiments. The steps of methods 100a, 100b, 100c may be repeated, implemented in various orders, and implemented concurrently.

Inventory management system 20 may include a processor coupled to a data storage device configuring a variety of hardware and software modules, including a sales and inventory management utility 50 (which may be referred to as inventory management utility 50), report generator 52, an alert generator 54, a marketing utility 56, a user interface utility 58, and a data management utility 60. These are example components, and inventory management system 20 may include fewer or more components in various embodiments.

Generally, inventory management system 20 provides (via user interface utility 58) an end-user front end is a highly configurable, self-serve user interface which may enable customizable dashboard views. The dashboard views may provide key item and POS metrics, charting and ad-hoc reporting (e.g., period over period comparisons, retailer over retailer comparisons), financial modeling/scenario planning, alerts and notifications (e.g., sales exceeding budget), schedulable push reporting (e.g., weekly sales summary), mobile access (smartphones, tablets), and key daily metrics at a store and SKU level. These metrics may include, for example, units sold, units on hand inventory, units on order, items by category or tag, retailers, average selling price, sales dollars, etc. Inventory management system 20 may be based on a SaaS model where different systems are running off the same instance. There may be multi-tenant users where retailers have separate data warehouses (physical or virtual).

Inventory management system 20 may include front end web interfaces (HTML5 or other web development language) which enables cross-platform viewing including mobile with exceptional performance. Inventory management system 20 may include a logic layer, e.g. report generator 52 querying the database. The back end may be a scalable high capacity/performance database taking hourly/daily/weekly data feeds from retailer POS systems potentially using a data integration utility if required (e.g., Informatica). Inventory management system 20 may have scalability and may have the ability to store and report on billions of scan transactions per year per retailer with fast response times. User interface utility 58 is configured to generate customizable user interfaces and reports for display on retailer systems 12, vendor systems 14, and user devices 16. The user interface receives input data and provides output data.

At 102, inventory management utility 50 is operable to receive retailer inventory data from a retailer system 12. The retailer inventory data identifies items in-stock or on order for one or more locations associated with the retailer system 12. The items may be supplied by one or more vendors associated with vendor systems 14. For each item, the retailer inventory data may include a SKU, a quantity in stock, a vendor (e.g. vendor codes), a cost, a location, coupon codes, retailer code (identifying the retailer system 12 the data was received from), date, time, item description, manufacturer, brand, tag, etc. The inventory management utility 50 is operable to receive retailer inventory data from multiple retailer systems 12. Inventory management utility 50 is operable to receive inventory data from vendor systems 14 as well, to correlate vendor and retailer inventory. A tag may define a class, category, or description for a product or service. This enables inventory management utility 50 to define items by different levels of granularity. For example, an item may be a hockey stick, and may be associated with a tag hockey and/or sporting equipment, As another example, an item may be toothpaste and may be associated with a tag dental hygiene. As a further example, an item may be frozen pizza and may be associated with a tag freezer item. A report may aggregate items by tag across multiple retailers to provide per tag reports of different levels of granularity. Inventory management utility 50 is operable to receive updates to inventory data as new inventor is received by retailers.

At 104, inventory management utility 50 is operable to store the retailer inventory data as retailer item records 64, via data management utility 60. Each item record 64 identifies and is associated with an item of those items from the retailer inventory data. Each item record 64 may store various data fields, such as for example, the SKU (for both the retailer and vendor if different), the quantity in stock, tag, a retailer code identifying the retailer system 12 the data was received from, a vendor code identifying the vendor, datestamp, timestamp, location, amount, description, applicable discounts/coupons, total charge, and the like. These are non-limiting, illustrative example data fields. If the SKU used by the retailer system 12 is different than the SKU used by the vendor system 14 then the later may be referred to as the vendor item code. Data may be received from multiple retailer systems 14 and the retailer code provides a mechanism to distinguish between data received from different retailers. The retailer code enables data aggregation for a particular retailer system 12 across multiple vendors. The vendor code enables data aggregation for a particular vendor system 14 across multiple retailers. The tag enables data aggregation for a particular class or category of product or service and enables data aggregation at different levels of granularity (e.g. SKU level, tag level). A retailer item record 64 may include multiple tags at different levels of granularity. This step may be repeated as additional data is received.

At 106, inventory management utility 50 is operable to receive POS data feeds from the retailer system 12. The data may be received on a periodic basis, e.g. hourly, daily, weekly, monthly. The POS data feeds includes sales data regarding items such as quantity sold, price, SKU, etc. The POS data feeds may include other data fields relating to a transaction and time, such as date sold, time sold, location sold, amount sold for, description, discounts/coupons used for sale, total charge of transaction item sold as part of, payment method, payment data, transaction identifier, customer data, loyalty program data, margin, tag, and the like. These are non-limiting, illustrative example POS data fields.

At 108, for each of the items identified in the sales data, inventory management utility 50 is operable to update the corresponding retailer item record 64 via data management utility 60 by adjusting the quantity in stock based on the quantity sold, and by including additional data fields from the POS data feeds. The additional data fields may be grouped per transaction, per retailer, per vendor, per SKU, etc. basis for subsequent data analysis and report generation. For example, an item may be sold to two different customers as part of two different transactions, and customer data for each transaction may be stored as part of the retailer item record 64. The SKU or other item identifier may be used as an index by data management utility 60 for each retailer item record 64.

At 110, a report generator 52 is operable to to generate reports based on the retailer item records 64, and other data managed by data management utility 60. The report may be an inventory report, retailer report, sales report, vendor report, product report, and so on.

Report generator 52 is operable to receive a variety of report parameters for generating reports. Example parameters include: SKU (for both the retailer and vendor if different), tag, a retailer code, a vendor code, date(s), time period, location, marketing data, description, discounts/coupons, and so on. Report generator 52 may aggregate data across multiple retailers for a particular vendor using the vendor code, for example. Report generator 52 may aggregate data across multiple vendors for a particular retailer using the retailer code, as another example. Report generator 52 may aggregate data based on SKU across multiple vendors and retailers, as a further example.

The report may include a variety of summary data and charts. For example, the report may be vendor focused and include data for all items linked to a particular vendor (via vendor code, for example) across multiple retailers. For example, a report may aggregate SKU data per vendor across all retailers for a particular time period to show sales and inventory trends. As another example, the report may be retailer focused and include data for all items linked to a particular retailer (via retailer code, for example) across multiple vendors. The report may include a total number of units of items sold and a total sales amount based on the costs per unit of items sold, for either a vendor or a retailer. The total number of units of items sold and the total sales amount may be per location for retailers.

Report generator 52 is also operable to run benchmarking reports that benchmark current data for a vendor or retailer against historical data or other vendor or retailer data. Report generator 52 is also operable to A/B comparison reports, comparing different retailers (and locations) and different vendors on a SKU level or store level basis. This provides the ability to set up a control and experimental group of stores to compare metrics.

Report generator 52 is also operable to provide budget based reports with the ability to enter in targets (e.g., from budget) to compare to actuals. Report generator 52 is operable to determine “zero sales stores” such as a histogram of weekly sales/store across a retailer in user configurable bands including zero sales stores. Report generator 52 is also operable to generate map based reports (e.g. store map of retailer store locations, heat map of territorial heat map showing store locations and colour coded for sales or inventory which may be store or state level colour coding, weather maps with ability to overlay weather feeds over store/heat map). The heat map may overlay demographic data and data feeds (e.g. weather) on sales data to identify further trends.

Report generator 52 is also operable to provide product based reports providing a summary of items per SKU for a retailer or vendor, along with metrics such as top sellers, low sellers, budget comparisons, cost comparisons, etc. The product reports may be generated using tags to aggregate data at different levels of granularity (e.g. SKU level v. tag level). The tag may identify one or more logical classes or categories that the product belongs to.

Report generator 52 is also operable to demographic based reports which may provide the ability to overlay demographic data feeds over other reports, such as map based reports (e.g. store/heat map). Report generator 52 is also operable to location/store/SKU reports with store level SKU sales and inventory charts. Additional report metrics may include top SKUs (report of top $ or units SKUs), top stores (report of top stores by retailer by SKU by sales $ or units), KPIs (user configurable key performance indicator summary). These metrics may be specific to a retailer (or location) or vendor. An aggregation all charts may be selected to show daily, weekly or monthly aggregation of data. There may also be ad hoc reports where users can build a report by choosing which metrics to chart/compare.

A reporting interface may include processing indicators which may be a time lapse indicator to let users know that their request is processing. An interface may also include a date picker (e.g. clickable calendar to pick specific date ranges) or other report parameter selector. A user can choose to compare to previous period or previous year and have that data appear on the same chart or report. A dashboard interface may also include widgets (e.g. all reports and charts may be tagged to be added as a widget to a user's dashboard). A user can drag and drop widgets in dashboard view to reorder as per user's preferences.

The report may be transmitted to a vendor system 14, retailer system 12, user device 16, or a combination thereof.

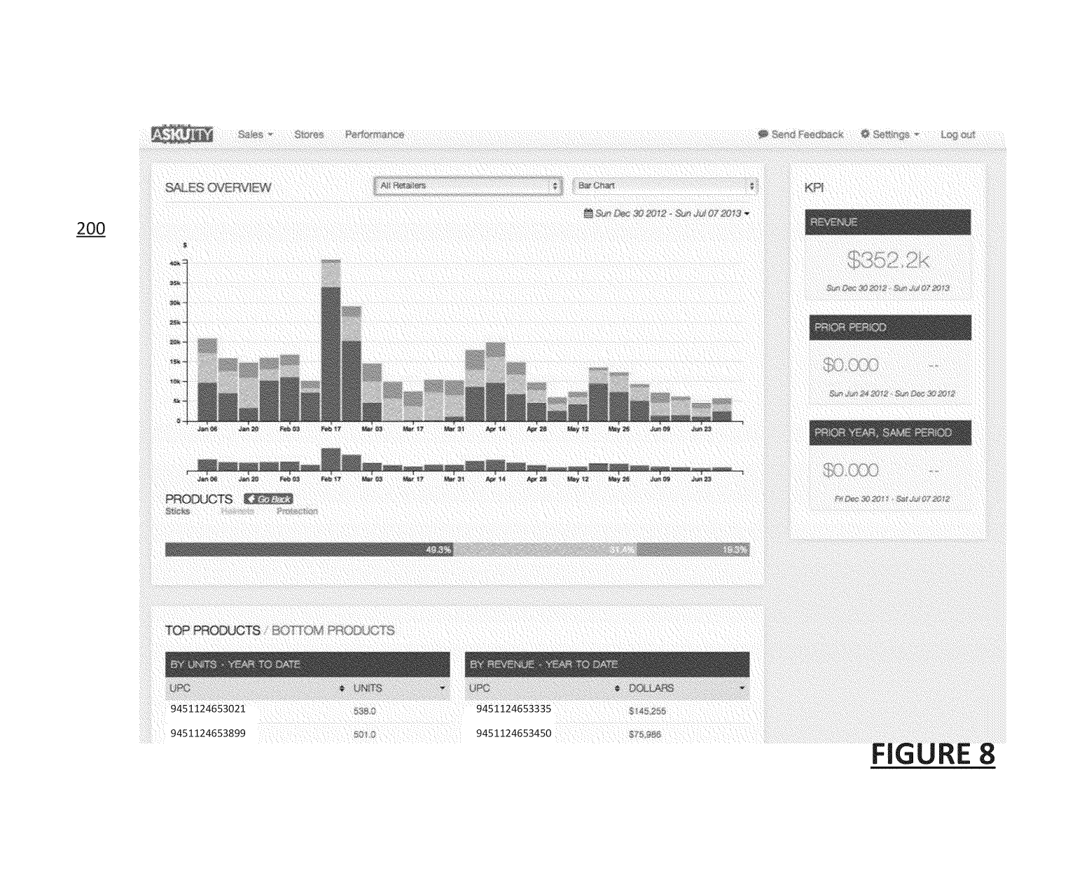

Referring now to FIG. 8, there is shown an example user interface 200 displaying sales and inventory management data according to some embodiments. The report may be a sales overview generated for received report parameters. The sales report may be for a particular vendor and may aggregate data across multiple retailers. The number of retailers may be provided as a report parameter (e.g. “all retailers”) and may be narrowed by region, etc. In this example, the report includes a bar chart, which may be configured as a different chart (e.g. line chart, pie chart) based on report parameters. The report may be a for a defined period of time (e.g. December 2012 to July 2013) as specified by a report parameter.

The bar chart may plot revenue or sales against time. The bar chart may distinguish between different products and also show an aggregate amount for all products. In this example, the products are sticks, helmets, and protection. The report may be generated per tag, such as sporting equipment, for example. The report may include a summary line showing a breakdown of product sales per percentage (e.g. 49.3%, 31.4%, 19.3%) per product.

The report may include summary data for the product sales, such as top products and bottom products, along with SKU, units sold, and revenue, for the defined time period. The report may include a summary of a Key Performance Indicator (KPI) including total revenue for the current period, along with benchmarking data such as total revenue for the prior period and the prior year, same period.

The interface 200 may provide configuration tools to change the type of report, send feedback, change settings, log out, and so on. The example report may be a sales or performance report.

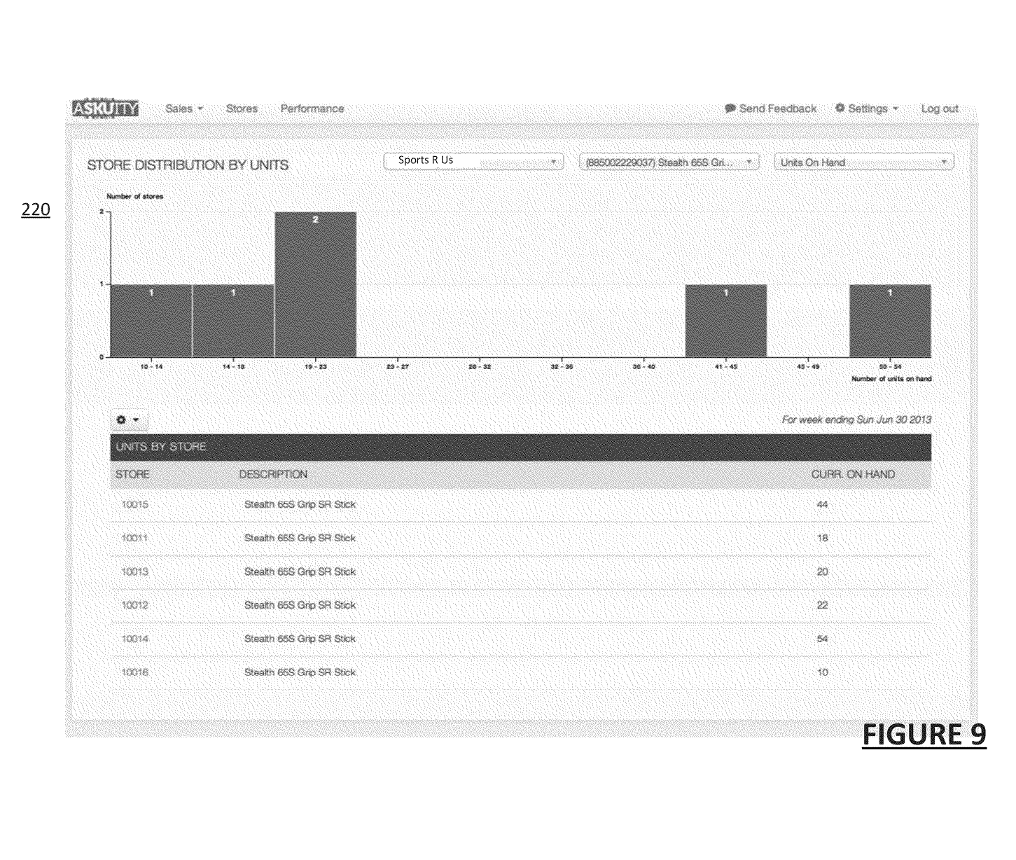

Referring now to FIG. 9, there is shown an another example user interface 220 displaying sales and inventory management data according to some embodiments. In this example, the report shows distribution by units for a particular retailer, product, store, location etc. The units may be units in stock for example. The example report may be an inventory report.

The retailer, product, location or region, and type of report (e.g. units in stock, units sold) may be received as report parameters, along with the time period for the report. A bar chart may plot number of stores (for a particular retailer) against number of units in stock. The report may aggregate data based on retailer and product. In this example, data for six stores for a retailer is shown. The report may be for different time periods such day, week, month, etc.

The report may include a summary listing of units by store, along with store identifier, description of product, SKU, number of units on hand, price, etc. The report may show different types of store distribution data by units other than units in stock, such as units sold, units on order, etc.

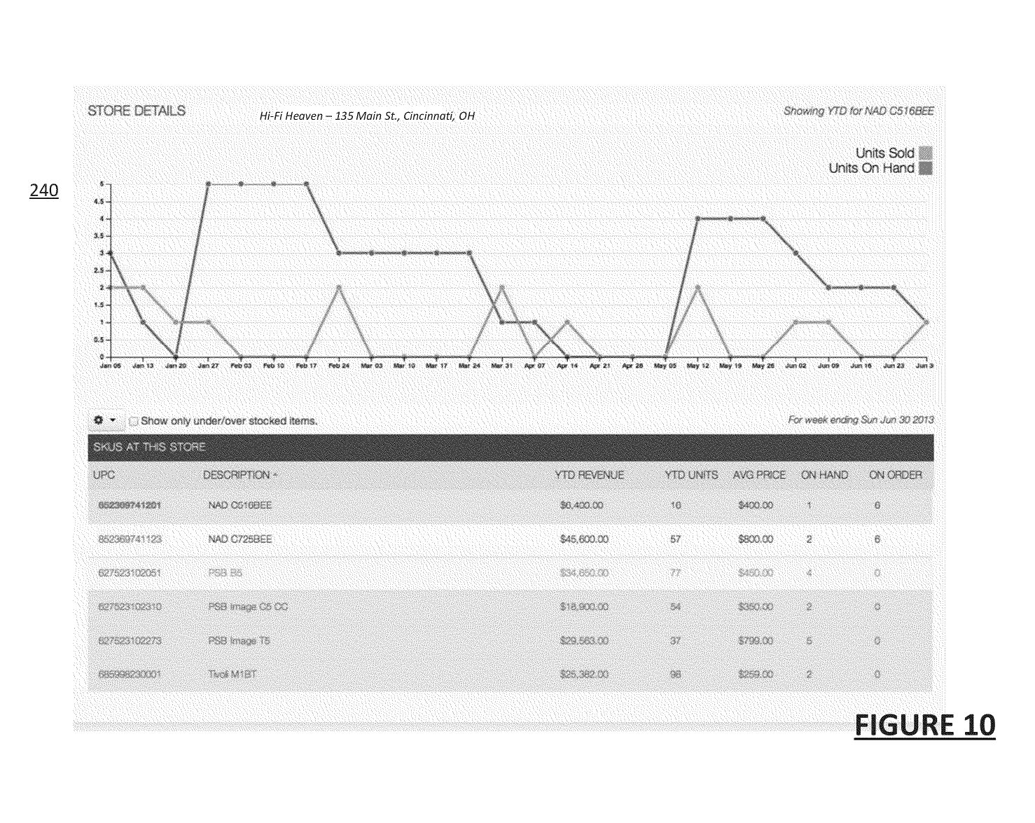

Referring now to FIG. 10, there is shown a further example user interface 240 displaying sales and inventory management data according to some embodiments. In this example, the report shows store details for a particular retailer store location (received and configurable via report parameters). The report may be for a particular SKU or for multiple SKUs, as per report parameters.

The report may include a line chart plotting number of units in stock and sold against time (e.g. days, weeks, months). The time period is configurable and dynamically updated as report parameter.

The report may include a summary listing of items at the store by SKU, description, year to date revenue, year to date units, average price, cost, margin, in stock, on order, etc. The listing may be modified to show different types or sets of products, such as understock or overstock items.

Method 100a may return to steps 102 to receive updates to inventory data or 106 to receive additional POS data feeds. Method 100a may return to and repeat other steps to dynamically update data and generate reports.

In some example embodiments, at 112 (FIG. 6), an alert generator 54 is operable to receive an alert threshold for an item. The alert threshold may include a SKU and a minimum quantity in stock for the item linked to the SKU. Alert configurations may be received to configure alerts, such as frequency, triggers, thresholds etc. Different retailers, products, or vendors may have different alert configurations.

The inventory management utility 50 is further configured to add the minimum quantity in stock to the retailer item record 64 for the item. Accordingly, the minimum quantity in stock is another example data field.

At 114, the alert generator 54 is further operable to determine whether the quantity in stock for the item is less than the minimum quantity in stock for the item.

If so, at 116, alert generator 54 is further operable to generate an alert for the item to order additional quantities from the vendor for the item. The alert generator 54 is further operable to transmit the alert to the retailer system 12 (for subsequent transmission to the vendor system 14), the vendor system 14, or both, to re-order and re-stock the item. This provides an automatic mechanism to alert vendors and retailers when an item is out-of-stock (e.g. the minimum quantity in stock is zero) or reaches a low level.

Alert generator 54 is further operable to recommend or suggest an optimal minimum quantity in stock based on trends (e.g. average shelf life for an item) to automatically optimizes re-ordering and re-stocking of items.

Additional notifications or alerts may also be generated. Some alerts may be user configurable alert based on metric parameter set. There may be summary emails (e.g. daily or weekly summary of selected key metrics) and messaging options (ability to share a report with another user through an email). There may also be vendor to retailer notifications of backorder, discontinued products, etc.

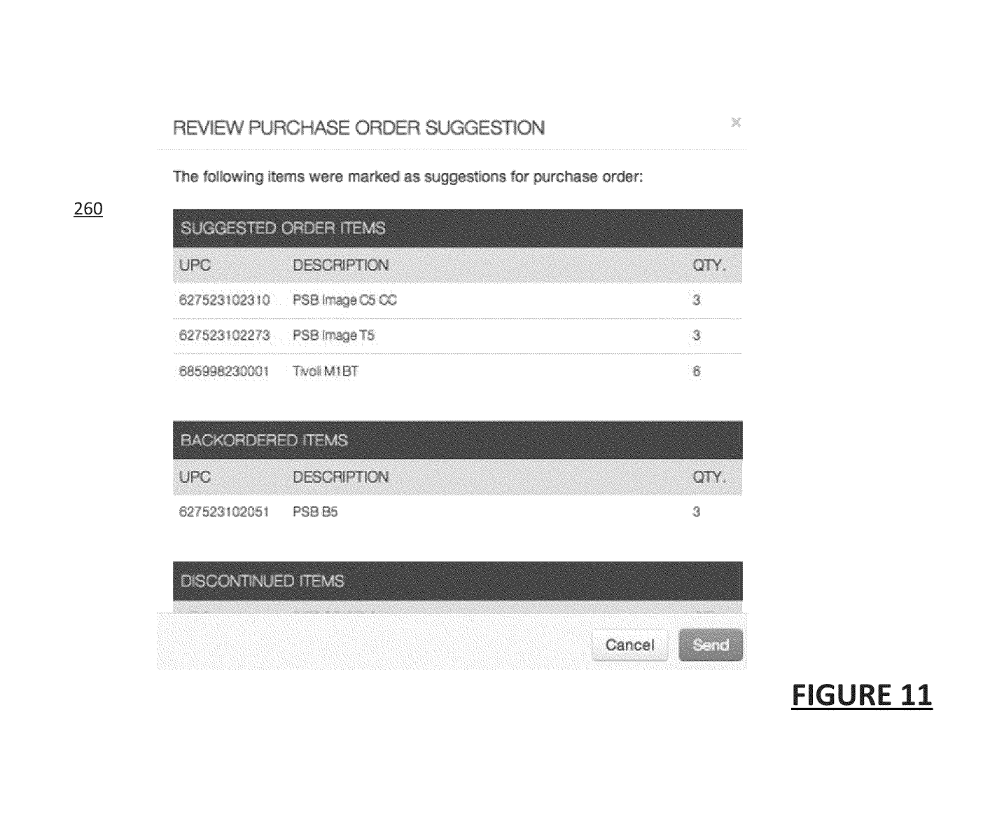

Referring now to FIG. 11, there is shown another example user interface 260 displaying an alert according to some embodiments. The alert in this example is a review purchase order suggestion that may be reviewed and approved prior to transmission. The purchase order may list suggested order items (triggered based on a threshold amount) along with SKU, description and order quantity. The order may also list backordered items and discontinued items. The purchase order may be automatically generated and sent to the relevant party. This provides an automated communication platform between vendors and retailers.

Method 100b may return to steps 102 to receive updates to inventory data or 106 to receive additional POS data feeds. Method 100b may return to and repeat steps in order to dynamically update data and generate alerts.

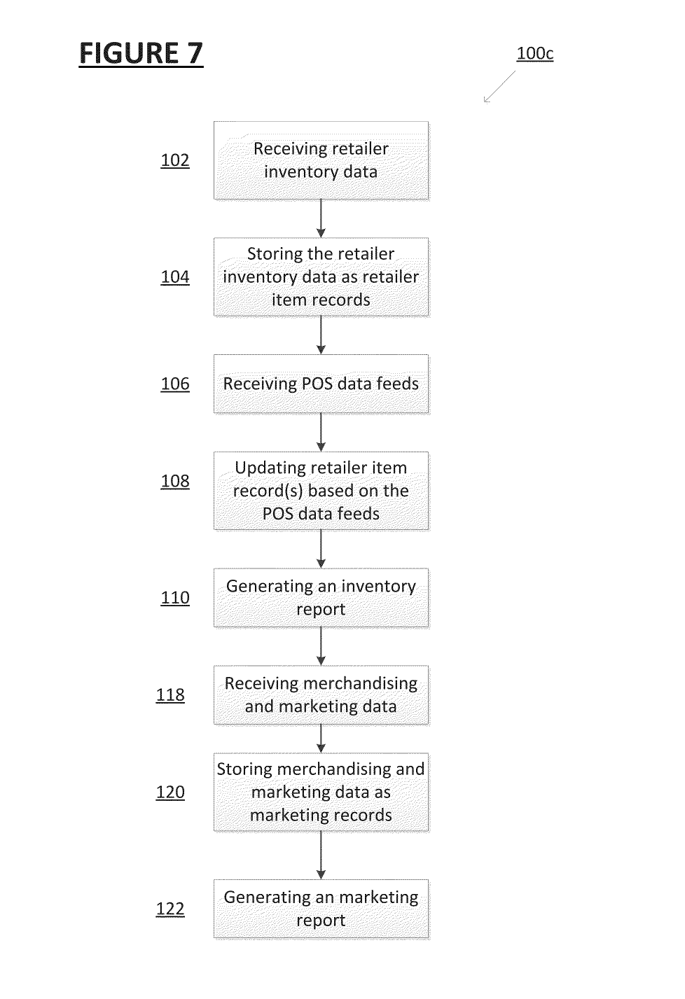

In some example embodiments, at 118 (FIG. 7), a marketing utility 56 is operable to receive merchandising and marketing data, where the merchandising and marketing data corresponds to one or more items, retailers, vendors etc.

At 120, the inventory management utility 50 is further operable to store the merchandising and marketing data as a marketing records 62 via data management utility 60. Merchandising and marketing data may provide details on what merchandising and marketing programs are currently offered by a vendor, currently used by the retailer, effectiveness, new marketing programs, promotional programs, loyalty programs, etc. Other examples include in-store demos, online ads, coupons, displays, etc. The marketing records 62 may include data fields based on the marketing data such as one or more SKUs for relevant items, descriptions, retailer data, vendor data, merchandising data, and so on.

At 122, the report generator 52 is further configured to generate a marketing report using the marketing records 62. The marketing report may link items sales to marketing data to illustrate trends and provide insight. Coupons and discounts may be linked to marketing data, for example.

Method 100c may return to steps 102 to receive updates to inventory data or 106 to receive additional POS data feeds.

The inventory management utility 50 may receive sales data that identifies customer data for each of the one or more items. The customer data may be stored separately as customer records 66 and linked to one or more items via a SKU or other data key. This data may be used by report generator 52 to generate demographic based reports to provide insight for vendors and retailers about their customer base. The customer data may be linked to items, SKU, vendor codes, retailer codes, etc.

The inventory management utility 50 may provide mobile specific functionality. For example, there may be a scan ability to call up SKU data based on scan of symbol (attached to item record). There may also be geolocation ability to call up sales/inventory data based on location. A geolocation may suggest stores nearby where you are that are in your data set that have a particular SKU item in stock. There may also be a KPI. The report may also provide data for the closest store (or current store that the mobile device is within) such as stock, sales, and marketing data.

The inventory management system 20 may provide an item data central repository for all item data that retailers and vendors can pull from. There may also be merchandising data capture abilities to track merchandising execution at store level, or retailer level. The inventory management system 20 may enable vendors and retailers to determine best practices for stocking and inventory management across retailers and vendors. The inventory management system 20 may enable optimized inventory levels (out of stock, overstock) and optimized marketing investments.

Other example reports may benchmark retailers against competitors and system 20 may organize retailers based on retailer type to identify competitors in order to aggregate and benchmark competitor data.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

What is claimed is:

1. A method for sales and inventory management of items offered for sale by at least one merchant and supplied by at least one vendor:
configuring a sales and inventory management utility and report generator using a processor coupled to a data storage device;
receiving, by the sales and inventory management utility, a plurality of sets of retailer inventory data from a plurality of retailer systems, wherein each set of retailer inventory data identifies a plurality of items, a tag, and for each of the plurality of items, a stock keeping unit (SKU), a quantity in stock, a retailer, and a vendor;
storing the plurality of sets of retailer inventory data as a plurality of retailer item records stored on the data storage device, each item record identifying an item of the plurality of items, the SKU, the quantity in stock, a retailer code for the retailer system, and a vendor code for the vendor;
receiving, by the sales and inventory management utility, point-of-sale data feeds from one or more retailer systems from the plurality of retailer systems, wherein the point-of sale data feeds comprises sales data, wherein the sales data identifies one or more items of the plurality of items, a retailer, and a quantity sold;
for each of the one or more items identified in the sales data, updating, by the sales and inventory management utility, the retailer item record on the data storage device by adjusting the quantity in stock based on the quantity sold; and
generating, by the report generator, a sales and inventory report based on the sales inventory data stored on the data storage device.

2. The method of claim 1, further comprising:
configuring an alert generator using the processor;
receiving, by the alert generator, an alert threshold for an item of the plurality of items, wherein the alert threshold comprises a minimum quantity in stock for the item;
adding the minimum quantity in stock to the retailer item record for the item;
determining, by the alert generator, that the quantity in stock for the item is less than the minimum quantity in stock for the item; and
generating, by the alert generator, an alert for the item to order additional quantities from the vendor for the item.

3. The method of claim 1, further comprising:
configuring an marketing utility using the processor;
receiving, by the marketing utility, merchandising and marketing data, wherein the merchandising and marketing data corresponds to one or more items of the plurality of items;
storing the merchandising and marketing data as a marketing records on the data storage device;
generating, by the report generator, a marketing report using the marketing records stored on the data storage device.

4. The method of claim 1 further comprising:
receiving a vendor item code for an item of the plurality of items, wherein the vendor item code for the item is different than SKU for the item; and
adding the vendor item code to the retailer item record for the item;
wherein the report is generated based on the vendor item code;

5. The method of claim 1 further comprising:
receiving a coupon code for an item of the plurality of items, wherein the coupon code identifies a discount on the item;
adding the coupon code to the retailer item record for the item;
wherein the sales data identifies the coupon code and indicates that discount was given on the item.

6. The method of claim 1 further comprising:
receiving reporting metrics, wherein the report metrics correspond to contents of the retailer item records;
wherein the report is generated based on the reporting metrics.

7. The method of claim 1, wherein the sales data identifies customer data for each of the one or more items, wherein the method further comprises:
for each of the one or more items, storing the customer data as a customer record on the data storage device, wherein the customer record comprises a customer identifier and the SKU for the item.

8. The method of claim 1, further comprising:
receiving, by the sales and inventory management utility, additional retailer inventory data from another retailer system, wherein the additional retailer inventory data identifies a plurality of additional items, and for each of the plurality of additional items, a SKU, a quantity in stock and a vendor;
storing the additional retailer inventory data as a plurality of additional retailer item records stored on the data storage device, each additional item record identifying an item of the plurality of additional items, the SKU, the quantity in stock, a retailer code identifying the other retailer system, and a vendor code identifying the vendor;
receiving, by the sales and inventory management utility, additional point-of-sale data feeds from the other retailer system, wherein the additional point-of sale data feeds comprises additional sales data, wherein the additional sales data identifies one or more items of the plurality of additional items and a quantity sold; and
for each of the one or more items identified in the additional sales data, updating, by the inventory management utility, the retailer item record on the data storage device by adjusting the quantity in stock based on the quantity sold.

9. The method of claim 1, wherein the method further comprises:
receiving a report request comprising a vendor code; and
wherein the report is generated based on the vendor code and by aggregating data based on retailer code across multiple retailer systems.

10. The method of claim 9, wherein the retailer inventory data identifies for each of the plurality of items, a cost per unit, and wherein, for each of the plurality of items, the retailer item record for the item comprises the cost per unit, cost margin, revenue, and wherein the method further comprises, aggregating, by the report generator based on the vendor code, a total number of units of items sold and a total sales amount based on the costs per unit of items sold, wherein the report comprises the total number of units of items sold.

11. The method of claim 9, wherein the vendor code is associated with a vendor system, and wherein the method further comprises:
transmitting the report to the vendor system,

12. The method of claim 1, wherein each item record identifies a retailer location.

13. The method of claim 12, further comprising aggregating, by the report generator based on the retailer location, a total number of units of items sold per location and a total sales amount per location based on the costs per unit of items sold.

14. The method of claim 1, wherein the report comprises, for each retailer item record having a retailer code identifying the retailer system, the SKU and the quantity in stock.

15. The method of claim 1, further comprising receiving a selection of tags or item metrics, wherein the item metrics correspond to contents of the retailer item records, and wherein the method further comprises generating the report, by the report generator, based on selected metrics.

16. A system for sales and inventory management of items offered for sale by at least one merchant and supplied by at least one vendor, the system comprising:
a data storage device;
a processor coupled to the data storage device;
a sales and inventory management utility configured by the processor to:
receive retailer inventory data from a retailer system, wherein the retailer inventory data identifies a plurality of items, and for each of the plurality of items, a stock keeping unit (SKU), a quantity in stock, and a vendor;
store the retailer inventory data as a plurality of retailer item records stored on the data storage device, each item record identifying an item of the plurality of items, the SKU, the quantity in stock, a retailer code identifying the retailer system, and a vendor code identifying the vendor;
receive point-of-sale data feeds from the retailer system, wherein the point-of sale data feeds comprises sales data, wherein the sales data identifies one or more items of the plurality of items and a quantity sold;
for each of the one or more items identified in the sales data, update the retailer item record on the data storage device by adjusting the quantity in stock based on the quantity sold; and
a report generator configured by the processor to generate a sales and inventory report based on the sales and inventory data stored on the data storage device.

17. The system of claim 16, further comprising:
an alert generator configured by the processor to receive an alert threshold for an item of the plurality of items, wherein the alert threshold comprises a minimum quantity in stock for the item;
wherein the sales and inventory management utility is further configured to add the minimum quantity in stock to the retailer item record for the item; and
and wherein the alert generator is further configured to determine that the quantity in stock for the item is less than the minimum quantity in stock for the item; and generate an alert for the item to order additional quantities from the vendor for the item.

18. The system of claim 16, further comprising:
a marketing utility configured by the processor to receiving merchandising and marketing data, wherein the merchandising and marketing data corresponds to one or more items of the plurality of items;
wherein the sales and inventory management utility is further configured to store the merchandising and marketing data as a marketing records on the data storage device;
wherein the report generator is further configured to generate a marketing report using the marketing records stored on the data storage device.

19. The system of claim 16, further comprising:
a user interface utility configured by the processor to generate a user interface for display on the retailer system, the user interface configured to receive input data and provide output data.

20. A computer-readable storage medium storing one or more sequences of instructions which, when executed by one or more processors, causes the one or more processors to perform a method for sales and inventory management of items offered for sale by at least one merchant and supplied by at least one vendor, the method comprising:
configuring a sales and inventory management utility and report generator using a processor coupled to a data storage device;
receiving, by the sales and inventory management utility, retailer inventory data from a retailer system, wherein the retailer inventory data identifies a plurality of items, and for each of the plurality of items, a stock keeping unit (SKU), a quantity in stock, and a vendor;
storing the retailer inventory data as a plurality of retailer item records stored on the data storage device, each item record identifying an item of the plurality of items, the SKU, the quantity in stock, a retailer code identifying the retailer system, and a vendor code identifying the vendor;
receiving, by the sales and inventory management utility, point-of-sale data feeds from the retailer system, wherein the point-of sale data feeds comprises sales data, wherein the sales data identifies one or more items of the plurality of items and a quantity sold;
for each of the one or more items identified in the sales data, updating, by the sales and inventory management utility, the retailer item record on the data storage device by adjusting the quantity in stock based on the quantity sold; and
generating, by the report generator, a sales and inventory report based on the sales and inventory data stored on the data storage device.
